(19) United States
(12) Patent Application Publication
(10) Pub. No.: US 2018/0015807 A1
(43) Pub. Date: Jan. 18, 2018

(54) VEHICLE WINDOW MOUNTED DISCRETE COOLING ASSEMBLY

(71) Applicant: Andrew Koo, Chandler, AZ (US)

(72) Inventor: Andrew Koo, Chandler, AZ (US)

(21) Appl. No.: 15/207,611

(22) Filed: Jul. 12, 2016

(51) Int. Cl. B60H 1/00; F25B 27/00

(52) U.S. Cl. CPC B60H 1/00478; F25B 27/002; B60H 1/00264; F25B 2321/0251; F25B 2321/023

(57) ABSTRACT

A vehicle window mounted cooling assembly for generating and distributing cooled air in a vehicle which is not running includes an assembly housing having a cooling and distributing electrical system, a mounting system, and a powering system. The cooling and distributing system includes a Peltier cooler, a heat sink, and a fan system, collectively arranged to disperse cooled air in a vehicle and outlet heated air out of a vehicle. The mounting system includes two securing notches which operate to allow the assembly housing to be removably secured in an open vehicle window. The powering system, which includes exterior solar panels, an internal battery, and a controller, allows for selective provision of electricity to the cooling and distributing system components. As such, the vehicle window mounted cooling assembly provides a self-contained, selectively attachable cooling device for a vehicle.

### BACKGROUND OF THE INVENTION

### Field of the Invention

This invention relates generally to cooling devices and, more particularly, to a self contained, discrete cooling assembly which employs an integrated thermoelectric cooler and fan.

### Description of the Prior Art

The use of common electrically driven cooling systems techniques, such as vapor-compression based systems, to cool a vehicle while in use is well known. A problem which still exists, however, is that such systems generally require too much electrical power to be used when a vehicle is not actually in use. A common problem for vehicle users is that when they leave their vehicle for a period of time in a warm and sunny environment, the temperature inside the vehicle typically will increase very quickly to an uncomfortable or possible unsafe temperature. Thus, there remains a need for a vehicle window mounted discrete cooling assembly which would operate without external power to keep a vehicle's internal temperature from increasing to an excessively high temperature. It would be helpful if such a vehicle window mounted discrete cooling assembly employed a thermoelectric cooler to provide a cooling effect and a fan to distribute cooled air into the vehicle. It would be additionally desirable for such a vehicle window mounted discrete cooling assembly to include both an electricity generator and a stored power supply to ensure the availability of electricity across varying circumstances.

The Applicant's invention described herein provides for a vehicle window mounted discrete cooling assembly adapted to generate and distributed cooled air in a vehicle interior when the vehicle is not running. The primary components in Applicant's vehicle window mounted discrete cooling assembly are a housing, cooler, fan and heat sink. When in operation, the vehicle window mounted discrete cooling assembly enables the maintenance of a vehicle interior's temperature even when the vehicle is not running. As a result, many of the limitations imposed by prior art structures are removed.

### SUMMARY OF THE INVENTION

A vehicle window mounted cooling assembly for generating and distributing cooled air in a vehicle which is not running. The vehicle window mounted cooling assembly comprises an assembly housing having a cooling and distributing electrical system, a mounting system, and a powering system. The cooling and distributing system includes a Peltier cooler, a heat sink, and a fan system, collectively arranged to disperse cooled air in a vehicle and outlet heated air out of a vehicle. The mounting system includes two securing notches which operate to allow the assembly housing to be removably secured in an open vehicle window. The powering system, which includes exterior solar panels, an internal battery, and a controller, allows for selective provision of electricity to the cooling and distributing system components. As such, the vehicle window mounted cooling assembly provides a self-contained, selectively attachable cooling device for a vehicle.

It is an object of this invention to provide a vehicle window mounted discrete cooling assembly which would operate without external power to keep a vehicle's internal temperature from increasing to an excessively high temperature.

It is another object of this invention to provide a vehicle window mounted discrete cooling assembly which employs a thermoelectric cooler to provide a cooling effect and a fan to distribute cooled air into the vehicle.

It is yet another object of this invention to provide a vehicle window mounted discrete cooling assembly which includes both an electricity generator and a stored power supply to ensure the availability of electricity across varying circumstances.

These and other objects will be apparent to one of skill in the art.

### BRIEF DESCRIPTION OF THE DRAWINGS

FIG. 1 is a side elevational view of a cross section of a vehicle window mounted discrete cooling assembly built in accordance with the present invention.

FIG. 2 is a front elevational view of a vehicle window mounted discrete cooling assembly built in accordance with the present invention.

FIG. 3 is a rear elevational view of a vehicle window mounted discrete cooling assembly built in accordance with the present invention.

### DETAILED DESCRIPTION OF THE INVENTION

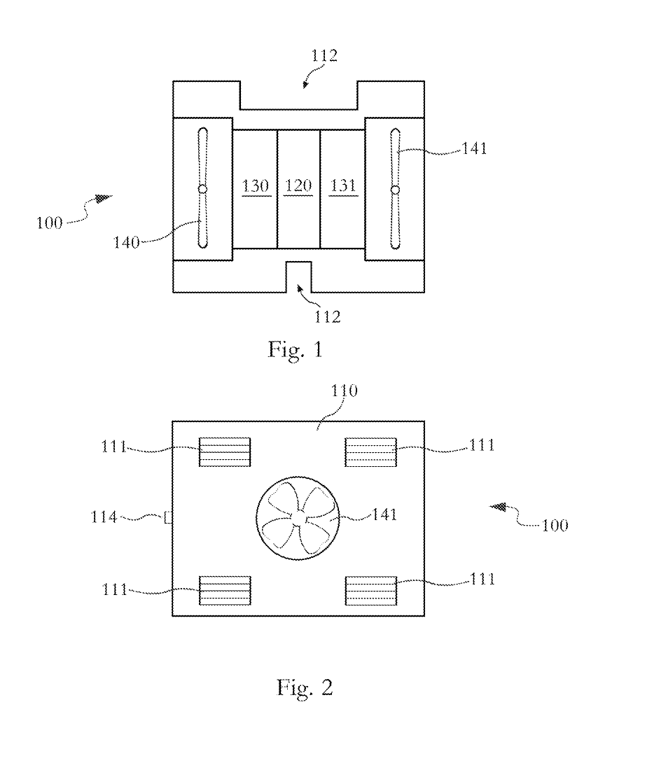

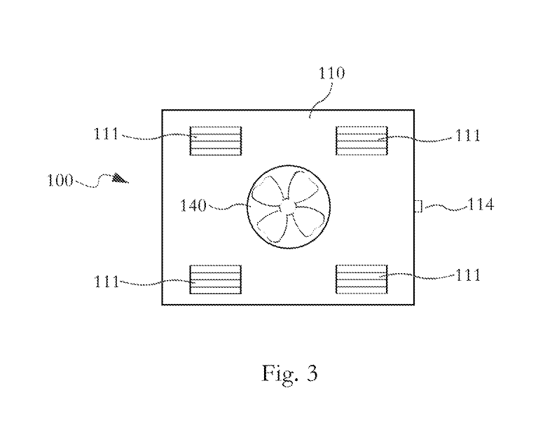

Referring now to the drawings and in particular FIGS. 1, 2, and 3, a vehicle window mounted cooling assembly 100 is shown having a Peltier cooler 120, opposing heat sinks 130, 131, and opposing fan systems 140, 141 each integral with an assembly housing 110. The exterior of the assembly housing 110 additionally includes solar panels 111 and two opposing securing notches 112. Internally, the assembly housing 110 includes an internal battery, a controller, and electrical wiring which connects the Peltier cooler 120, heat sinks 130, 131, and fan systems 140, 141 with the solar panels 111 and battery by way of the controller. In this regard, the controller is wired to monitor the supply of electricity from each of the solar panels 111 and battery and selectively supply electricity from either solar panels 111 or battery to the Peltier cooler 120, heat sink 130, 131, and fan system 140, 141.

When desired to be used, vehicle window mounted cooling assembly 100 may be positioned on the top edge of a conventional vehicle window, with the window positioned in the one of the securing notches 112 and the frame of the vehicle positioned between the other securing notch 112, thereby wedging the vehicle window mounted cooling assembly 100 between the window and door frame of the vehicle.

It is contemplated that when the window mounted cooling assembly 100 is in place on a window, the window would not be able to be completely closed.

In operation, when the Peltier cooler 120, heat sinks 130, 131, and fan system 140, 141 are supplied electricity, the Peltier cooler 120 operates to absorb heat from the cool side heat sink 130 and cool air which may pass therethrough. When the assembly housing 110 is positioned with the cool side of the Peltier cooler 120 on the inside of a vehicle, cooled air is then pulled from the heat sink 130 by the cool side fan system 140, which operates to blow the air into the interior of the vehicle. At the same time, the hot side heat sink 130 absorbs heat from the heated side of the Peltier cooler 120, thereby heating air which may pass therethrough. This heated air is pulled away from the heat hot side heat sink 130 by the cool side fan system 140 and directed away from the vehicle on which the window mounted cooling assembly 100 is mounted.

In one embodiment, an actuator button 114 when operates to reverse the polarity of the flow of electrical power to the Peltier cooler 120, thereby flipping the hot and cold sides.

In one embodiment, a timer is integrated with the controller to allow the provision of electrical power to the Peltier cooler 120, heat sinks 130, 131, and fan systems 140, 141 to be automatically initiated or automatically terminated after a preset amount of time.

In one embodiment, the controller is programmed to use solar power from the solar panels 111 when available and only use battery power when solar power is not available or sufficient.

In one embodiment, a remote control is included to control the operation of the vehicle window mounted cooling assembly 100.

In one embodiment, the vehicle window mounted cooling assembly 100 is included in a vehicle when the vehicle is manufactured.

The instant invention has been shown and described herein in what is considered to be the most practical and preferred embodiment. It is recognized, however, that departures may be made therefrom within the scope of the invention and that obvious modifications will occur to a person skilled in the art.

1. A vehicle window mounted cooling assembly attachable to a vehicle window of a target vehicle, comprising:
an assembly housing adapted to be attached to an edge of the vehicle window of the target vehicle such that the assembly housing simultaneously extends into the interior of the target vehicle and to the exterior of the target vehicle, wherein said assembly housing includes at least one integrated power source, the assembly housing comprising;
a first securing notch embodied as an indentation within a top portion of the assembly housing to allow at least a portion of a door frame of the vehicle window to fit therewithin, and
a second securing notch embodied as an indentation within a bottom portion of the assembly housing to allow at least a portion of the vehicle window to fit therewithin;
a Peltier cooler integral with said assembly housing and connected to said power source, wherein said Peltier cooler includes a first side and a second side;
a first heat sink integral with said assembly housing and connected to said power source, wherein said first heat sink is positioned on said assembly housing such that the first heat sink is adjacent to the first side of the said Peltier cooler;
a second heat sink integral with said assembly housing and connected to said power source, wherein said second heat sink is positioned on said assembly housing such that the second heat sink is adjacent to the second side of the said Peltier cooler
a first fan system integral with said assembly housing and connected to said power source, wherein said first fan system is positioned adjacent to the first heat sink and adapted to pull air away from the first heat sink.

2. The vehicle window mounted cooling assembly of claim 1, wherein said assembly housing includes a plurality of discrete integrated power sources.

3. The vehicle window mounted cooling assembly of claim 2, wherein said plurality of discrete integrated power sources includes an internal battery and a solar panel.

4. The vehicle window mounted cooling assembly of claim 1, wherein said at least one power source defines a solar panel.

5. The vehicle window mounted cooling assembly of claim 1, additionally comprising a second fan system integral with said assembly housing and connected to said power source, wherein said second fan system is positioned adjacent to the second heat sink and adapted to pull air away from the second heat sink.

6. The vehicle window mounted cooling assembly of claim 5, wherein said assembly housing includes a plurality of discrete integrated power sources.

7. The vehicle window mounted cooling assembly of claim 6, wherein said plurality of discrete integrated power sources includes an internal battery and a solar panel.

8. The vehicle window mounted cooling assembly of claim 5, wherein said at least one power source defines a solar panel.
